(19) United States
(12) Patent Application Publication
(10) Pub. No.: US 2024/0227497 A1
(43) Pub. Date: Jul. 11, 2024

(54) VEHICLE HEATING SYSTEM

(71) Applicant: FORD GLOBAL TECHNOLOGIES, LLC, Dearborn, MI (US)

(72) Inventors: Adam Nathan Banker, Canton, MI (US); Westin Pusey, Brownstown, MI (US); Rohan Shrivastava, Livonia, MI (US); James C. Rollinson, Superior Township, MI (US)

(21) Appl. No.: 18/150,978

(22) Filed: Jan. 6, 2023

(51) Int. Cl. B60H 1/00

(52) U.S. Cl. CPC B60H 1/00771; B60H 1/00478; B60H 1/00828; B60H 1/00885

(57) ABSTRACT

A heating system for a vehicle includes both a heat pump and an electric resistance heater. A controller calculates a parameter which indicates the relative importance of noise and efficiency based on vehicle location, charging status, time of day, etc. Based on the parameter, the controller operates the heat pump and the electric resistance heater to satisfy a cabin heat demand in a manner that reflects the relative importance of the attributes.

### TECHNICAL FIELD

The present invention relates to a vehicle heating system. More particularly, the disclosure concerns a vehicle heating system in which use of a heat pump and electric resistance are balanced based on specified factors including vehicle location.

### BACKGROUND

Electrified vehicles may utilize electric mechanisms for cabin heating. These mechanisms may include electric resistance heaters and heat pumps. These two types of electric heating have different properties in terms of noise generation and efficiency.

### SUMMARY

A vehicle heating system includes a heat pump, an electric resistance heater, and a controller. Thea heat pump has a compressor and a fan. The fan may be configured to move exterior air through a heat exchanger of the heat pump. The controller is programmed to control the compressor, the fan, and the electric resistance heater to supply heat at a requested rate. A limit speed of the compressor and a limit speed of the fan are based on at least a present location of the vehicle. The limit speed of the compressor and the limit speed of the fan may be higher when the present location of the vehicle is within a user specified region than when the present location is outside the user specified region. The limit speed of the compressor and the limit speed of the fan may also be based on whether the vehicle is currently connected for charging to a charging station, a state of charge of a vehicle battery, or a time of day.

A method of controlling a vehicle heating system having an electric resistance heater and a heat pump with a compressor includes setting a speed of the compressor based on a present location of the vehicle and controlling the electric resistance heater such that a combined heat output of the heat pump and the electric resistance heater is equal to a demanded heating rate. The speed of the compressor may also be based on whether the vehicle is currently connected for charging to a charging station, a state of charge of a vehicle battery, or a time of day. The method may include receiving, from a user, boundaries of regions in which one of the heat pump and the electric resistance heater should be favored over the other. The speed of the compressor is then based on whether the present location of the vehicle is within the user-specified boundaries. A parameter may indicate a relative preference between use of the heat pump and use of the electric resistance heater based on the present location of the vehicle. A maximum compressor speed may be based on the parameter. In response to a heat output of the heat pump at the maximum compressor speed exceeding the demanded heating rate, the heat pump may be operated to produce the demanded heating rate. In response to the heat output of the heat pump at the maximum compressor speed not exceeding the demanded heating rate, the heat pump may be operated at the maximum compressor speed.

A vehicle includes a cabin, a heat pump, an electric resistance heater, and a controller. The heat pump is configured to move heat at a first rate from an exterior of the vehicle into the cabin. The heat pump has a compressor. The electric resistance heater is configured to provide heat to the cabin at a second rate. The controller is programmed to control the heat pump and the electric resistance heater such that a sum of the first rate and the second rate is equal to a cabin heat demand. A speed of the compressor is based on a present location of the vehicle. The speed of the compressor may be based on whether the present location of the vehicle is within a user specified region. The speed of the compressor may also be based on whether the vehicle is currently connected for charging to a charging station, a state of charge of a vehicle battery, or a time of day.

### BRIEF DESCRIPTION OF THE DRAWINGS

FIG. 1 illustrates a vehicle with a heating system.

FIG. 2 is a schematic diagram of a vehicle heating system.

FIG. 3 is a flow chart for a method of controlling the heating system of FIG. 2.

FIG. 4 is a flow chart for a method of calculating a parameter in the method of FIG. 3.

FIG. 5 is a flow chart for user editing of data used in the method of FIG. 4.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates a vehicle 10. The vehicle may be an electrified vehicle such as a hybrid electric vehicle, a plug-in hybrid electric vehicle, or a battery electric vehicle. Plug-in hybrid electric vehicles and battery electric vehicles may be connected for charging to a charging station. The connection may be, for example, a physical plug or a magnetic connection as used in inductive charging. The vehicle includes a heating system 12 to heat the occupant cabin. The heating system may be used when the vehicle is occupied and may also be used to pre-heat the cabin when the vehicle is not occupied, such as when it is parked in a garage or parking lot.

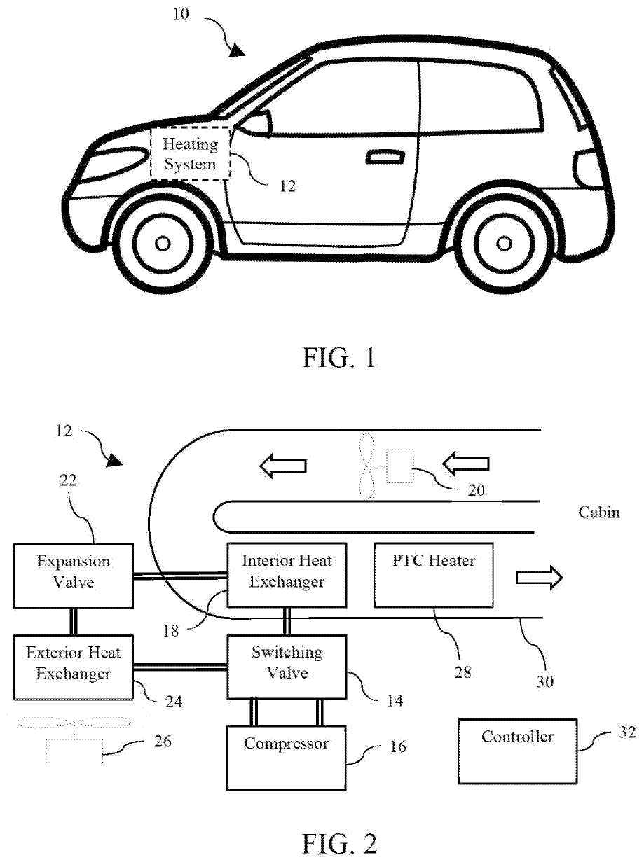

FIG. 2 schematically illustrates the heating system 12. The heating system may include a bidirectional vapor compression cycle heat pump which moves heat between the exterior and the vehicle cabin. The direction of heat movement is based on the position of switching valve 14. For convenience, the system will be described in heating mode. Alternatively, the system may include a unidirectional heat pump configured only to move heat into the cabin. A compressor 16, compresses a vapor phase refrigerant causing a temperature of the refrigerant to increase to a temperature higher than the cabin interior temperature. The hot refrigerant flows through an interior heat exchanger 18 where heat is transferred to interior cabin air. The refrigerant changes phase from vapor to liquid in the heat exchanger releasing additional heat. A blower fan 20 may propel the cabin air through the interior heat exchanger. The refrigerant then flows through an expansion valve 22 and changes phase from liquid to vapor causing it to cool to a temperature less than the exterior air temperature. The refrigerant absorbs heat from ambient outdoor air as it flows through exterior heat exchanger 24 on its way back to compressor 16. A fan 26 propels exterior air through exterior heat exchanger 24.

The heating system 12 also includes a Positive Temperature Coefficient (PTC) heater 28, also known as an electric resistance heater. PTC heater 28 generates heat from electrical current flowing through a resistance. Ductwork 30 guides cabin air from the blower fan 20 through the interior heat exchanger 18 and the PTC heater 28 back to the cabin. Controller 32 controls the speeds of fans 20 and 26, the speed of compressor 16, and the position of switching valve 14. When cabin heat is turned on, the controller calculates the heating demand, i.e. the requested heating rate in btu/hr.

The two potential heat sources have different characteristics. The heat pump is more energy efficient. In other words, the heat pump is capable of delivering more heat to the cabin per unit of electrical energy input. However, compressor 16 and fan 26 generate noise which is related to their speeds. The relative importance of these attributes differs based on the situation. For example, some locations are noise sensitive due to other activities that take place in those locations. In such locations, it may be preferable to rely primarily on the PTC heater. In other locations, noise is not a concern and efficiency should be prioritized. For battery electric vehicles, the importance of efficiency increases when the state of charge is low, especially if it is low relative to the remaining distance to be traveled. On the other hand, when the vehicle is connected for charging, electrical power consumed for heating may be immediately replaced such that range is not decreased at all. In such situations, efficiency may be relatively less important.

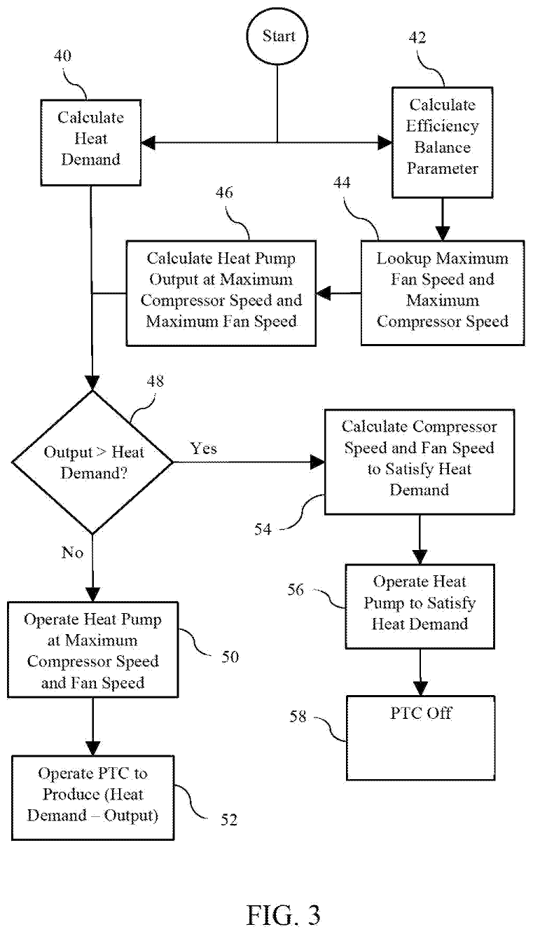

FIG. 3 illustrates a process for controlling a vehicle heating system like the system illustrated in FIG. 2. At 40, the controller calculates the heat demand which means the rate at which heat should be added to the vehicle cabin. This may be based on based on a user manipulable control such as a control knob or electronic control in the cabin. Alternatively, a user may adjust the setting remotely using a smart phone or an internet interface. At 42, the controller calculates a value for an EfficiencyBalance parameter representing a relative preference between use of the heat pump and use of the electric resistance heater. For example, EfficiencyBalance may be set to 0.0 when efficiency is not at all important, set to 1.0 when noise is not at all important, and set to intermediate values when both attributes should be given some weight. The calculation may be based on the vehicle location, whether or not the vehicle is connected for charging, a state of charge of a battery, a time of day, or other factors determinable by the controller. A sample method for computing EfficiencyBalance is discussed below. At 44, the controller consults a lookup table to find a maximum compressor speed and maximum fan speed for the value of EfficiencyBalance calculated at 42.

At 46, the controller calculates the rate at which the heat pump will provide heat to the cabin if it is operated at the maximum compressor speed and maximum fan speed determined at 44. The controller considers other factors that influence the output of the heat pump such as the current cabin temperature and the current ambient outdoor temperature. At 48, the output calculated at 46 is compared to the demand calculated at 40. If the calculated heat pump output is insufficient satisfy the demand, the heat pump is operated at the maximum compressor speed and maximum fan speed at 50 and the PTC heater is operated to make up the difference at 52. If the calculated heat pump output exceeds the demand at 48, then the controller calculates, at 54, the compressor speed and fan speed to satisfy the demand and operates it at those speeds at 56. In that case, the PTC is turn off at 58.

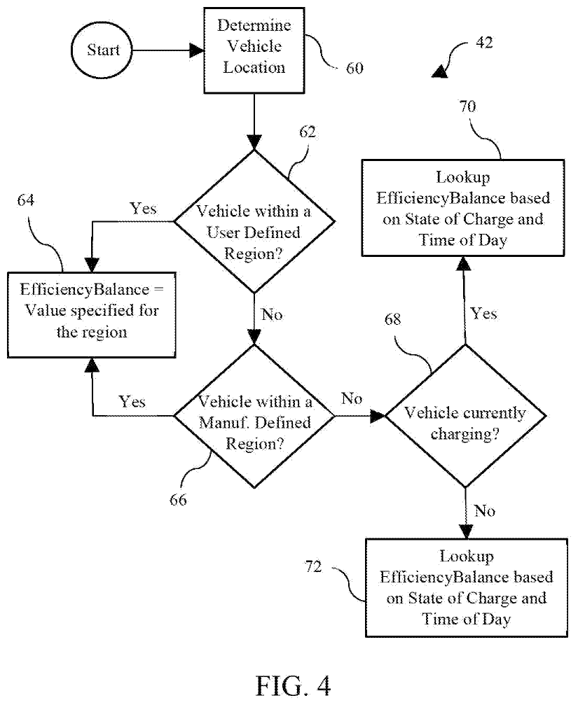

FIG. 4 illustrates an exemplary procedure to calculate the EfficiencyBalance parameter. At 60, the control determines the vehicle's location. At 62, the controller compares the vehicle location with user-specified boundaries of regions in which the user has indicated a preference for high efficiency or quietness. Possible methods for users to express that preference will be discussed below. For example, a user may indicate a region near a window of the residence as noise sensitive and a region away from the residence as not noise sensitive. If the present location is within any of the boundaries, EfficiencyBalance is set at 64 to a value that the user specified for that region. If the present location is not within any user specified boundaries, the present location is compared to manufacturer specified boundaries at 66. The manufacturer may preload a database of noise sensitive regions and noise insensitive regions when the vehicle is sold. If it is within a manufacturer specified region, EfficiencyBalance is set to the value specified by the manufacturer for that region at 64. At 68, the controller determines whether the vehicle is connected for charging to a charging station. Based on the this determination, it looks up the value of EfficiencyBalance at either 70 or 72 based on the state of charge and the time of day.

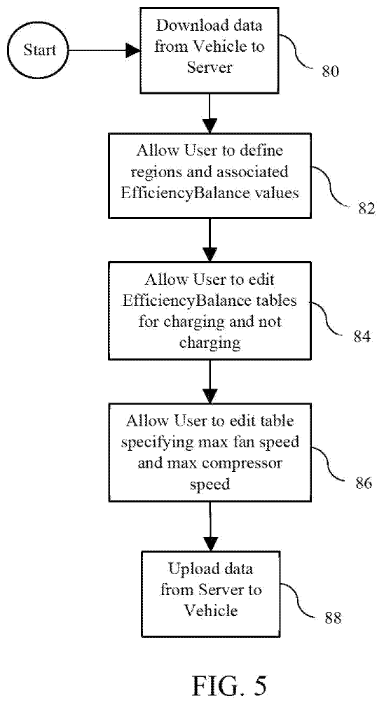

Although the manufacturer may provide default data to determine EfficiencyBalance, it may be beneficial to allow the vehicle owner, or another vehicle user, to edit and supplement that data. FIG. 5 illustrates a method for user modification of the criteria used to set EfficiencyBalance. The user may interact with a server, which exchanges data via Wifi or other protocol with the vehicle. At 80, the present data set is downloaded from the vehicle to the server. At 82, the user defines the boundaries regions and indicates the corresponding EfficiencyBalance value. The user may also be allowed to edit or delete previously defined user regions and potentially manufacturer defined regions. At 84, the user is provided an opportunity to edit the lookup tables used at 70 and 72. At 86, the user may be provided an opportunity to edit the tables which specific the maximum compressor speed and maximum fan speed as a function of EfficiencyBalance at 44. Finally, at 88, the server uploads the revised data to the vehicle controller 32.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A vehicle heating system, comprising:
a heat pump having a compressor and a fan;
an electric resistance heater; and
a controller programmed to control the compressor, the fan, and the electric resistance heater to supply heat at a requested rate, wherein a limit speed of the compressor and a limit speed of the fan are based on a present location of the vehicle.

2. The vehicle heating system of claim 1 wherein the limit speed of the compressor and the limit speed of the fan are higher when the present location of the vehicle is within a user specified region than when the present location is outside the user specified region.

3. The vehicle heating system of claim 1 wherein the limit speed of the compressor and the limit speed of the fan are further based on whether the vehicle is currently connected for charging to a charging station.

4. The vehicle heating system of claim 1 wherein the limit speed of the compressor and the limit speed of the fan are further based on a state of charge of a vehicle battery.

5. The vehicle heating system of claim 1 wherein the limit speed of the compressor and the limit speed of the fan are further based on a time of day.

6. The vehicle heating system of claim 1 wherein the fan is configured to move exterior air through a heat exchanger of the heat pump.

7. A method of controlling a vehicle heating system, the heating system having an electric resistance heater and a heat pump with a compressor, the method comprising:
setting a speed of the compressor based on a present location of the vehicle; and
controlling the electric resistance heater such that a combined heat output of the heat pump and the electric resistance heater is equal to a demanded heating rate.

8. The method of claim 7 further comprising setting the speed of the compressor based on whether the vehicle is currently connected for charging to a charging station.

9. The method of claim 7 further comprising setting the speed of the compressor based on a state of charge of a vehicle battery.

10. The method of claim 7 further comprising setting the speed of the compressor based on a time of day.

11. The method of claim 7 further comprising:
receiving, from a user, boundaries of regions in which one of the heat pump and the electric resistance heater should be favored over the other; and
setting the speed of the compressor based on whether the present location of the vehicle is within the user-specified boundaries.

12. The method of claim 7 wherein setting the speed of the compressor based on the present location of the vehicle comprises:
setting a parameter indicative of a relative preference between use of the heat pump and use of the electric resistance heater based on the present location of the vehicle;
setting a maximum compressor speed based on the parameter;
in response to a heat output of the heat pump at the maximum compressor speed exceeding the demanded heating rate, operating the heat pump to produce the demanded heating rate; and
in response to the heat output of the heat pump at the maximum compressor speed not exceeding the demanded heating rate, operating the heat pump at the maximum compressor speed.

13. The method of claim 7 wherein the heat pump further includes a heat exchanger and a fan configured to move exterior air through the heat exchanger, the method further comprising setting a speed of the fan based on the present location of the vehicle.

14. A vehicle comprising:
a cabin;
a heat pump configured to move heat at a first rate from an exterior of the vehicle into the cabin, the heat pump having a compressor;
an electric resistance heater configured to provide heat to the cabin at a second rate; and
a controller programmed to control the heat pump and the electric resistance heater such that a sum of the first rate and the second rate is equal to a cabin heat demand, wherein a speed of the compressor is based on a present location of the vehicle.

15. The vehicle of claim 14 wherein the speed of the compressor is based on whether the present location of the vehicle is within a user specified region.

16. The vehicle of claim 14 wherein the speed of the compressor is further based on whether the vehicle is currently connected for charging to a charging station.

17. The vehicle of claim 14 wherein the speed of the compressor is further based on a state of charge of a vehicle battery.

18. The vehicle of claim 14 wherein the speed of the compressor is further based on a time of day.

19. The vehicle of claim 14 wherein the heat pump further includes a heat exchanger and a fan configured to move exterior air through the heat exchanger and wherein a speed of the fan is based on the present location of the vehicle.
